(19) United States
(12) Patent Application Publication
(10) Pub. No.: US 2026/0009537 A1
(43) Pub. Date: Jan. 8, 2026

(54) ADJUSTABLE LOW PRESSURE REGULATOR FOR FEEDING GAS TO OUTDOOR COOKING STATION AND METHOD THEREOF

(71) Applicant: North Atlantic Imports, LLC, Logan, UT (US)

(72) Inventors: Gary E. Graham, Hyde Park, UT (US); Michael R. GiebeI, Joplin, MO (US)

(21) Appl. No.: 19/238,433

(22) Filed: Jun. 14, 2025

Related U.S. Application Data
(63) Continuation-in-part of application No. 18/967,515, filed on Dec. 3, 2024.
Application No. 18/967,515 is a continuation of application No. 17/461,904, filed on Aug. 30, 2021, now Pat. No. 12,158,267.
(60) Provisional application No. 63/072,653, filed on Aug. 31, 2020.
(60) Provisional application No. 63/660,503, filed on Jun. 15, 2024.

(51) Int. Cl. F23N 1/00; A47J 37/07

(52) U.S. Cl. CPC F23N 1/007; A47J 37/0713; F23N 2235/16; F23N 2235/24; F23N 2239/04

(57) ABSTRACT

Embodiments of a pressure regulator for delivering gas to a cooking station. The pressure regulator includes a body defining a gas inlet and a gas outlet. The body also includes a knob coupled to the body, the knob manually rotatable about an axis defined by the knob. Such knob of the pressure regulator is rotatable to adjust an output pressure of the pressure regulator. Further, the knob and body of the pressure regulator includes altitude indicia associated therewith. In one embodiment, the pressure regulator is sized and configured to be adjusted to compensate for a change in elevation of a geographical location of the person utilizing the adjustable regulator with the cooking station such that the knob may be adjusted so that the altitude indicia corresponds with the geographical location and the elevation thereof.

### CROSS-REFERENCE TO RELATED APPLICATIONS

This application claims the benefit of U.S. Provisional Patent Application No. 63/660,503, filed Jun. 15, 2024, the disclosure of which is hereby incorporated by reference herein in its entirety. Further, this application is a continuation-in-part of U.S. patent application Ser. No. 18/967,515, filed Dec. 3, 2024, which is a continuation of U.S. patent application Ser. No. 17/461,904, filed Aug. 30, 2021, now U.S. Pat. No. 12,158,267, which claims the benefit of U.S. Provisional Patent Application No. 63/072,653, filed Aug. 31, 2020, the disclosures of which are hereby incorporated by reference herein in their entirety.

### TECHNICAL FIELD

The present invention relates generally to regulating the feeding of fuel to a cooking station and, more specifically, the present invention relates to a low pressure adjustable regulator for feeding propane from a propane tank to a cooking station.

### BACKGROUND

Barbequing has become a popular and pervasive tradition in much of the world. A barbeque grill is a device for cooking food by applying heat directly below a grill. There are several varieties of grills but most fall into one of two categories, either gas fueled or charcoal. Gas fueled grills typically use propane or natural gas as a fuel source, with the gas flame either cooking the food directly or heating grilling elements which in turn radiate the heat necessary to cook the food. Grilling has become a popular method of cooking food due to the unique flavors and texture imparted to the food during the grilling process. Further, gas type fuel for grilling for many has become the favored type due to the advantages related to time efficiency of gas type outdoor grilling.

However, one problem with gas type fuel is controlling the amount of fuel that can be delivered to an outdoor cooking station. The means used for minimizing the pressure from a fuel tank or fuel line is by employing a pressure regulator, connected between the propane tank or the fuel line and the cooking station. The type of pressure regulators for fueling an outdoor cooking station are made to minimize the pressure to a relatively low pressure that is typically measured in inches water column. The typical “low pressure” regulators are non-adjustable and provide a fuel pressure of about 11 inches water column. Also, typical pressure regulators are made to act under a pressure gauge principle, which is based on the atmospheric pressure. Therefore, while low pressure regulators at sea level provide a pressure of about 11 inches water column, if one travels to a higher altitude at, for example, 6,000 feet above sea level, the decrease in air pressure causes the regulator to deliver propane at a lower density resulting in fewer BTU's being delivered to the burners.

### BRIEF SUMMARY OF THE INVENTION

The present invention is directed to various embodiments of a pressure regulator for delivering gas to an outdoor cooking station, the cooking station being couplable to gas fuel controllable with a gas knob. The pressure regulator includes a body and a lever arm. The body includes a knob rotatably coupled to the body, the knob manually rotatable about an axis defined by the knob. The body defines a gas inlet and a gas outlet. The lever arm is positioned within the body, the lever arm having an end portion positioned adjacent the gas inlet such that, upon the gas knob being in an open position, the lever arm is pivotable via rotation of the knob such that rotation of the knob adjusts gas flow pressure through the body between about 11 inches water column and about 15 inches water column. With this arrangement, a surface of the body and knob are associated with altitude indicia so that the knob is turnable to a position to adjust gas flow pressure through the body that corresponds with and compensates for a geographical altitude.

In another embodiment, the altitude indicia includes marking indicia, the marking indicia being positioned on at least one of the knob and the body. In another embodiment, the knob is turnable relative to the body to adjust the gas flow pressure through the body. In still another embodiment, the altitude indicia includes numerals associated with elevation above sea level.

In another embodiment, the knob is rotatable to linearly move an axil, the axil operatively coupled to at least one spring, the at least one spring operatively coupled to the lever arm. In another embodiment, the knob is rotatable to linearly move a relief pin, the relief pin operatively coupled to at least one spring and the lever arm. In another embodiment, the relief pin is linearly movable along the axis defined by the knob and relative to the body.

In another embodiment, the pressure regulator further includes a compartment, the compartment defined at least partially by the body and a diaphragm, the diaphragm moveable between an expanded position and a compressed position. In another embodiment, upon the diaphragm being in the compressed position, the lever arm is in a first pivoted position and, upon the diaphragm being in the expanded position, the lever arm is in a second pivoted position. In another embodiment, the diaphragm extends alongside a diaphragm plate.

In accordance with another embodiment of the present invention, an outdoor cooking station configured to be gas heated with a propane tank is provided. The outdoor cooking station includes a main body, an elongated interconnection member, and a pressure regulator. The main body includes gas burners, the gas burners configured to receive pressurized gas therethrough. The elongated interconnection member extends between a first end portion and a second end portion, the first end portion sized and configured to be coupled to the propane tank and the second end portion sized and configured to be operatively coupled to the gas burners so that gas can move from the propane tank to the gas burners of the main body. The pressure regulator is positioned between the first end portion and the second end portion of the interconnection member. The pressure regulator includes a body and a lever arm positioned within the body. The body includes a knob rotatably coupled to the body, the knob manually rotatable about an axis defined by the knob. The body of the pressure regulator defines a gas inlet and a gas outlet. The lever arm extends with an end portion positioned adjacent the gas inlet, the lever arm pivotable via rotation of the knob such that rotation of the knob is configured to adjust gas flow pressure through the body between about 11 inches water column and about 15 inches water column. With this arrangement, a surface of the body and knob are associated with altitude indicia so that the knob is turnable to a position to adjust gas flow pressure through the body that corresponds with and compensates for a geographical altitude.

In another embodiment, the altitude indicia includes marking indicia, the marking indicia being positioned on at least one of the knob and the body. In another embodiment, the knob is turnable relative to the body to adjust the gas flow pressure through the body. In another embodiment, the altitude indicia includes numerals associated with elevation above sea level.

In another embodiment, the interconnection member includes a flexible gas hose extending from the pressure regulator to the second end portion of the interconnection member. In another embodiment, the knob is rotatable to linearly move an axil, the axil operatively coupled to at least one spring, the at least one spring operatively coupled to the lever arm. In another embodiment, the knob is rotatable to linearly move a relief pin, the relief pin operatively coupled to at least one spring and the lever arm. In another embodiment, the relief pin is linearly movable along the axis defined by the knob and relative to the body.

In another embodiment, the pressure regulator includes a compartment, the compartment defined at least partially by the body and a diaphragm, the diaphragm moveable between an expanded position and a compressed position. In another embodiment, upon the diaphragm being in the compressed position, the lever arm is in a first pivoted position and, upon the diaphragm being in the expanded position, the lever arm is in a second pivoted position. In another embodiment, the diaphragm extends alongside a diaphragm plate.

In accordance with another embodiment of the present invention, a method for changing a fuel pressure to gas burners of a cooking station is provided. The method includes the steps of: providing a propane tank configured to feed fuel to the gas burners of the cooking station such that an interconnection member extends between the propane tank and the cooking station, the interconnection member having a gas hose and a pressure regulator each extending between the propane tank and the cooking station; turning a propane tank knob of the propane tank to an open position; and adjusting an output pressure of the propane gas being fed to the cooking station by moving a pressure regulator knob of the pressure regulator relative to altitude indicia associated with a surface of the pressure regulator knob and a body of the pressure regulator.

In another embodiment, the adjusting step includes rotating the knob relative to the body to adjust the gas flow pressure through the body to compensate for a change in elevation. In another embodiment, the adjusting step includes compensating for change in the pressure through the pressure regulator due to a change in elevation. In another embodiment, the adjusting step includes adjusting the pressure of the pressure regulator within the range between about 11 inches of water column and about 15 inches of water column. In another embodiment, the adjusting step includes rotating the pressure regulator knob to the altitude indicia that generally corresponds with the altitude of a user cooking on the cooking station. In still another embodiment, the rotating step includes adjusting the pressure of the propane gas facilitated by the pressure regulator to compensate for the altitude of the user cooking on the cooking station relative to sea level.

In another embodiment, the adjusting step includes moving an axil linearly to move an end portion of a lever arm to and from a gas inlet of the pressure regulator. In another embodiment, the adjusting step includes minimizing the pressure of the propane gas moving through pressure regulator by expanding a compartment of the pressure regulator such that the compartment is defined at least partially by a flexible diaphragm. In another embodiment, the adjusting step includes changing a size of a compartment of the pressure regulator with movement of a flexible diaphragm, the flexible diaphragm moveable with movement of the pressure regulator knob. In another embodiment, the changing step includes expanding the compartment to minimize the pressure of the propane gas being fed through the pressure regulator.

In accordance with another embodiment of the present invention, an outdoor cooking station configured to be gas heated with a propane tank associated with an elongated interconnection member, the elongated interconnection member extending between a first end portion and a second end portion, the first end portion sized and configured to be coupled to the propane tank, is provided. The outdoor cooking station includes a main body and a pressure regulator. The main body includes gas burners, the gas burners configured to receive pressurized gas therethrough, the gas burners configured to be operatively coupled to the second end portion of the elongated interconnection member so that gas is moveable from the propane tank to the gas burners of the main body. The pressure regulator is positioned between the first end portion and the second end portion of the interconnection member. The pressure regulator includes a body and a lever arm positioned within the body. The body includes a knob rotatably coupled to the body, the knob manually rotatable about an axis defined by the knob, the body defining a gas inlet and a gas outlet. The lever arm extends with an end portion positioned adjacent the gas inlet, the lever arm pivotable via rotation of the knob such that rotation of the knob is configured to adjust gas flow pressure through the body between about 11 inches of water column and about 15 inches of water column. With this arrangement, a surface of the body and the knob are associated with altitude indicia so that the knob is turnable to a position to adjust gas flow pressure through the body that corresponds with and compensates for a geographical altitude of a position of the cooking station.

In another embodiment, the altitude indicia includes marking indicia, the marking indicia being positioned on at least one of the knob and the body. In another embodiment, the knob is turnable relative to the body to adjust the gas flow pressure through the body. In still another embodiment, the altitude indicia includes numerals associated with elevation above sea level.

In accordance with another embodiment of the present invention, a pressure regulator for delivering gas to an outdoor cooking station, the cooking station being couplable to gas fuel controllable with a gas knob, is provided. The pressure regulator includes a body with a knob rotatably coupled to the body, the knob manually rotatable about an axis defined by the knob, the body defining a gas inlet and a gas outlet, the knob rotatable to adjust gas flow pressure through the body between the range of about 11 inches water column and about 15 inches water column. With this arrangement, a surface of the body and the knob are associated with altitude indicia so that the knob is turnable to a position to adjust gas flow pressure through the body that corresponds with and compensates for a geographical altitude.

In another embodiment, the altitude indicia includes marking indicia, the marking indicia being positioned on at least one of the knob and the body. In another embodiment, the knob is turnable relative to the body to adjust the gas flow pressure through the body. In still another embodiment, the altitude indicia includes numerals associated with elevation above sea level.

### BRIEF DESCRIPTION OF THE SEVERAL VIEWS OF THE DRAWINGS

The foregoing and other advantages of the invention will become apparent upon reading the following detailed description and upon reference to the drawings in which:

FIG. 1 is a perspective side view of an outdoor cooking station, depicting an interconnection member for coupling between a propane tank and the outdoor cooking station, according to an embodiment of the present invention;

FIG. 2 is a perspective view of the interconnection member, the interconnection member having an adjustable low pressure regulator associated therewith, according to another embodiment of the present invention;

FIG. 3 is a side view of the interconnection member of FIG. 2, according to another embodiment of the present invention;

FIG. 4 is a top view of the interconnection member of FIG. 2, according to another embodiment of the present invention;

FIG. 5 is an end view of the interconnection member of FIG. 2, according to another embodiment of the present invention;

FIG. 6 is a cross-sectional view of the interconnection member taken along section line A-A of FIG. 4, depicting the adjustable low pressure regulator in a maximized pressure position, according to another embodiment of the present invention;

FIG. 6A is an enlarged view of the adjustable low pressure regulator taken from region 6A of FIG. 6, according to another embodiment of the present invention;

FIG. 7 is a cross-sectional view of the interconnection member, depicting the adjustable low pressure regulator in a minimized pressure position, according to another embodiment of the present invention;

FIG. 7A is an enlarged view of the adjustable low pressure regulator taken from region 7A of FIG. 7, according to another embodiment of the present invention;

FIG. 8 is a perspective view of another embodiment of an adjustable pressure regulator associated with an interconnection member, depicting the adjustable pressure regulator with altitude indicia associated with the knob and body of the pressure regulator, according to the present invention;

FIG. 9 is a top view of the adjustable pressure regulator of FIG. 8, according to another embodiment of the present invention; and

FIG. 10 is a perspective view of another embodiment of an adjustable pressure regulator, depicting altitude indicia on a body of the adjustable pressure regulator and marking indicia on the knob of the adjustable pressure regulator.

### DETAILED DESCRIPTION OF THE INVENTION

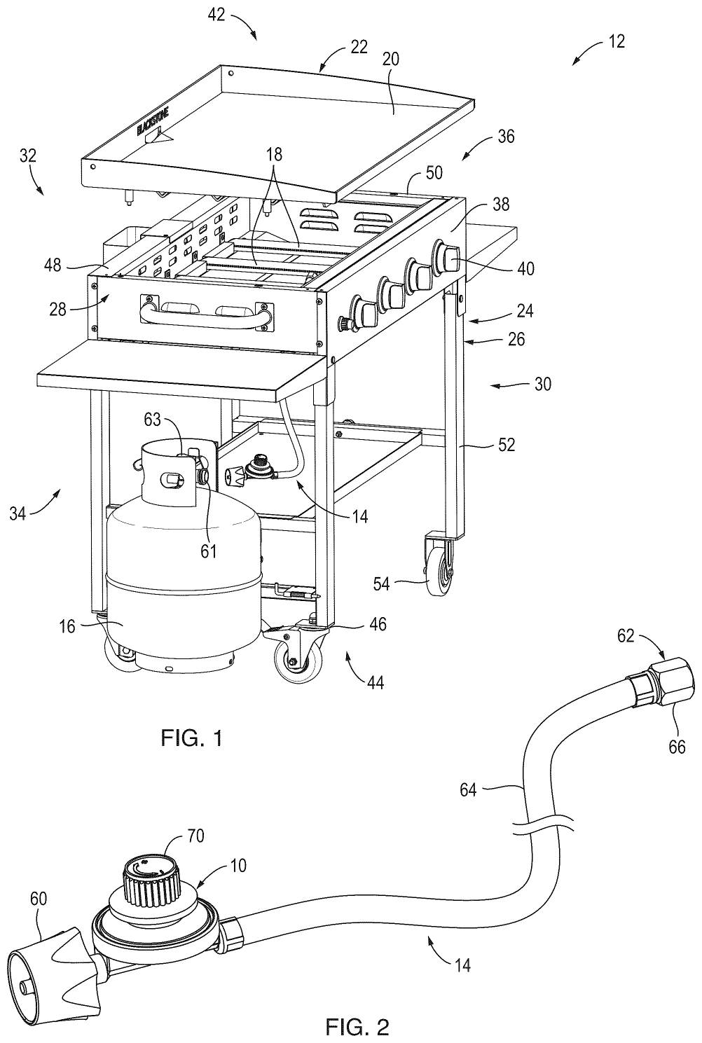

Referring to FIGS. 1 and 2, a pressure regulator 10 integrated with the connection components for feeding fuel, such as propane gas, to a cooking station 12 is provided. For example, in one embodiment, such pressure regulator 10 may be a portion of an interconnection member 14 sized and configured to feed fuel from a propane tank 16 to the cooking station 12. Further, the pressure regulator 10 may be sized and configured to facilitate manual adjustment of the gas pressure and amount of gas being fed to the cooking station 12 from a typical gas pressure level to various lower pressure levels, relative to the typical pressure level. In this manner, the pressure regulator 10 discussed herein may facilitate minimizing gas pressure (relative to a typical gas pressure) configured to be supplied or fed to a cooking station so that a user may cook at lower temperatures or to be more fuel efficient, for example.

The cooking station 12 may be of the type for outdoor use and may also be portable. The cooking station 12 may be any type of outdoor cooking station sized and configured to be gas fueled. As such, the cooking station 12 may include multiple gas burners 18 positioned below a cooking surface 20. The cooking surface 20 may be a griddle 22, as depicted. In another embodiment, the cooking surface 20 may be a grill type surface. The outdoor cooking station 12 may extend with a main body 24 with a frame structure 26 and panels 28 coupled to the frame structure 26. The main body 24 may extend to define a front side 30, a rear side 32, a first side 34 and a second side 36. The front side 30 may be opposite the rear side 32 and the first side 34 may be opposite the second side 36. The front side 30 may include a front panel 38 with multiple burner valve knobs 40 each associated with one of the gas burners 18 such that the gas burners 18 may be supported by the main body 24 so as to extend between the front and rear sides 30, 32 of the main body 24. Further, the main body 24 may define a top side 42 and a bottom side 44, the top side 42 extending opposite the bottom side 44. The burner valve knobs 40 may be sized and configured to be manually rotated to various positions and configured to feed gas to the gas burners 18 at various controlled levels or amounts corresponding to the various positions, as known to one of ordinary skill in the art,. The cooking station 12 may include various other structural components integrated or associated therewith that may be employed and/or may be necessary to facilitate delivering gas to the gas burners 18 and facilitate causing the gas burners 18 to burn, as known by one of ordinary skill in the art.

The main body 24 may also extend between a lower end 46 and an upper end 48. The upper end 48 may extend to define an edge 50 sized and configured to support the griddle 22 or the grill. In one embodiment, the main body 24 may support a hood (not shown) that may be pivotably coupled to the griddle 22 or pivotably coupled adjacent the upper end 48 of the main body 24 so as to cover the griddle 22 or grill. The main body 24 may also include multiple legs 52 with two or more wheels 54. In another embodiment, each of the legs 52 may exhibit one wheel 54, such as four caster wheels, at the lower end 46 of the main body 24. In this manner, the two or more wheels 54 of the cooking station 12 may readily facilitate portability of the cooking station 12. In another embodiment, the cooking station 12 may be an insert type cooking station 12 sized and configured to maintain a fixed position relative to cabinets or a counter the cooking station 12 is positioned within. As such, the cooking station 12 can be any type of gas fueled cooking station that may be employed with the interconnection member 14 having the pressure regulator 10, as set forth herein.

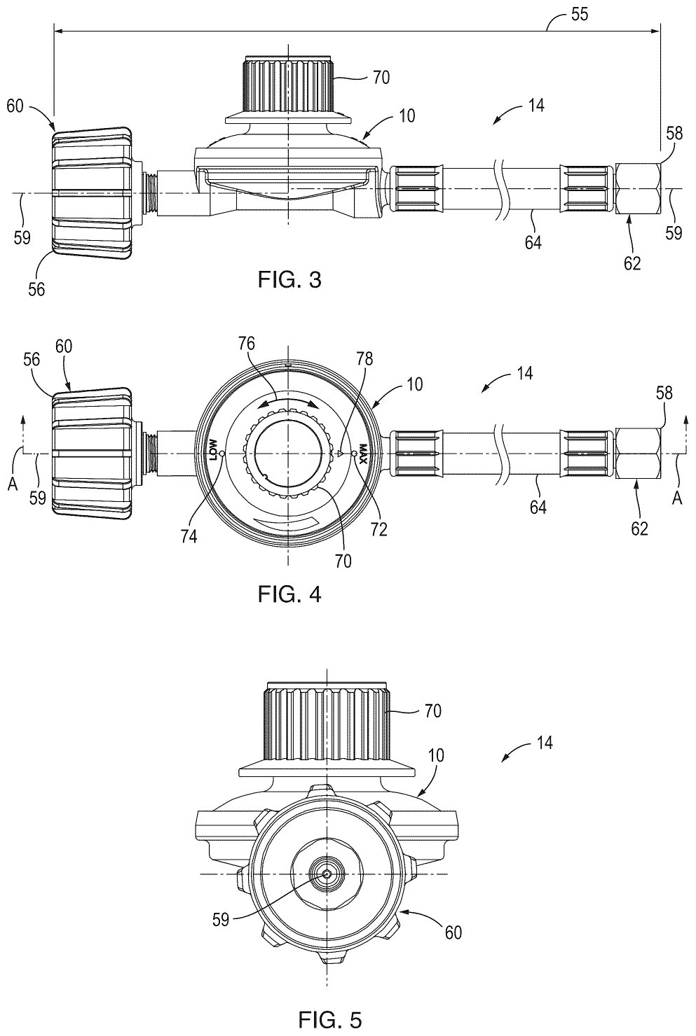

With reference to FIGS. 1-5, as previously set forth, the interconnection member 14 may extend between the propane tank 16 and the cooking station 12. The interconnection member 14 may be an elongated structure defining a length 55 that extends between first and second ends 56, 58 and defines a longitudinal axis 59 along the length of the elongated structure. The first end 56 may be associated with a propane coupling member 60 and the second end 58 may be associated with a cooking station coupling member 62 with the pressure regulator 10 and a hose 64 therebetween. The hose 64 may be sized and configured to deliver gas therethrough and may be flexible (as depicted in FIGS. 1 and 2). The propane coupling member 60 may include a valve with a safety tripping switch (not shown) sized and configured to couple to the propane tank 16, the safety tripping switch configured to automatically shut-off gas flow from the propane tank upon there being an un-safe amount of propane being delivered from the propane tank 16, as known to one of ordinary skill in the art. Further, the propane coupling member 60 of the interconnection member 14 may be coupled directly to a threaded portion 61 of the propane tank 16 such that the propane tank may include a gas knob that may be rotated between open and closed positions, the open position facilitating feeding gas from the propane tank 16, through the pressure regulator 10 and to the cooking station 12. The cooking station coupling member 62 may be in the form of a nut 66, the nut 66 sized and configured to be operatively coupled to the structural components necessary for delivering propane gas to the gas burners 18. The nut 66 may be rotatably coupled to one end of the hose 64.

Further, the pressure regulator 10 may include a rotatable knob 70 thereon. Such rotatable knob 70 may be rotated, as shown by arrow 76, between a maximum pressure position 72 and a minimum pressure position 74. Such maximum and minimum pressure positions 72, 74 may be indicated on the pressure regulator 10 with markings and may exhibit indicia for such markings in the form of “MAX” and “LOW,” respectively, on the pressure regulator 10 with a knob marking 78 on the knob 70 indicating the position of the rotatable knob 70 relative to the maximum and minimum pressure positions 72, 74. In one embodiment, the rotatable knob 70 may be rotated, in total, about 180 degrees, between the maximum and minimum pressure positions 72, 74. In the minimum pressure position 74, the pressure regulator 10 is not in a closed-off position, but rather, is a position that delivers gas in a minimal amount to the cooking station 12 so long as gas from the propane tank 16 is applying pressure to the pressure regulator 10 such that gas knob 63 of the propane tank 16 is in an open position. Such minimal amount for delivering gas may be helpful for minimizing a heating temperature, similar to a simmering arrangement, of the cooking station 12 and/or for the purpose of increasing fuel efficiency. With this arrangement, the interconnection member 14 may be employed to feed fuel to the cooking station 12 with the propane coupling member 60 sized and configured to be directly coupled to the propane tank 16 and the cooking station coupling member 62 sized and configured to be directly coupled to the cooking station 12 such that the pressure regulator 10 may be manually turned to a desired position so as to adjust or manipulate the amount of gas flow through the interconnection member 14.

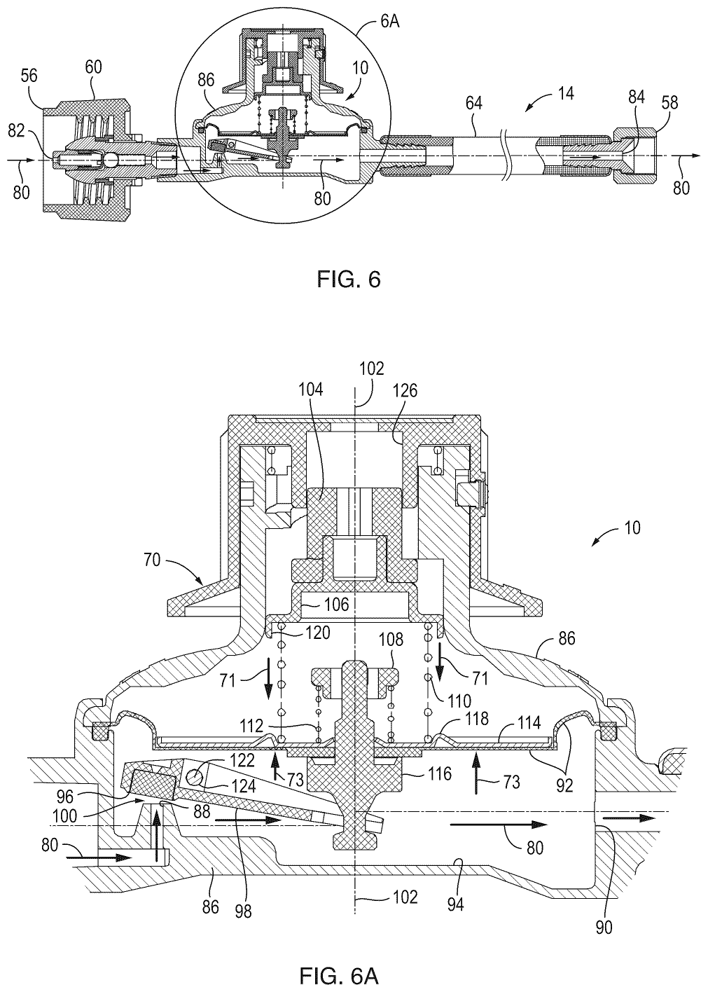

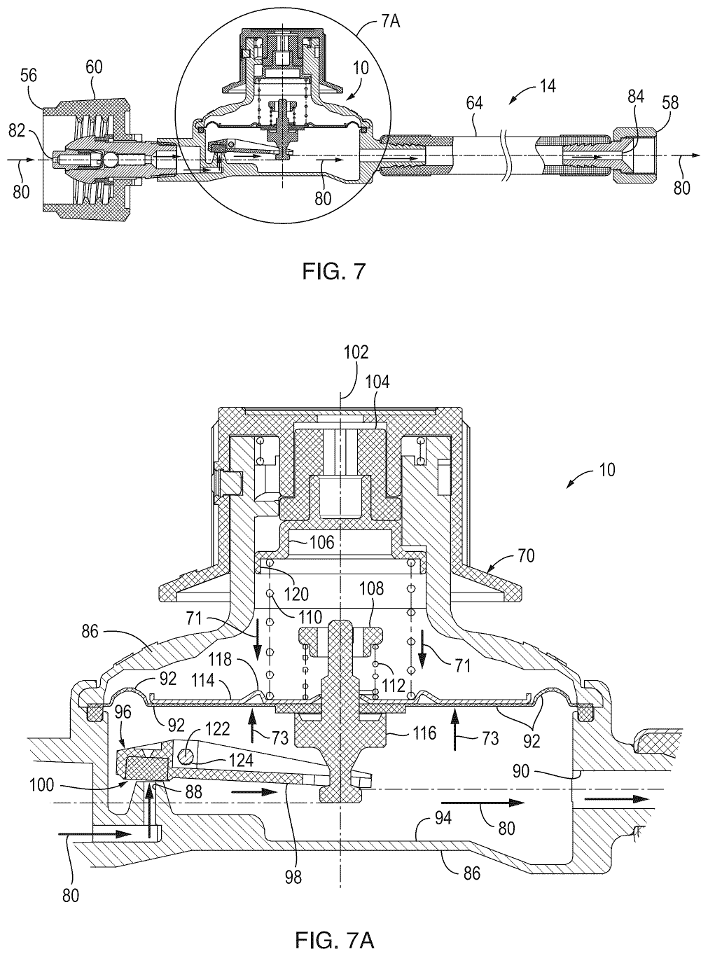

Now with reference to FIGS. 4, 6 and 7, gas flow is depicted with arrow 80 through the interconnection member 14 with the pressure regulator 10 in the maximum pressure position 72 (FIG. 6) and the minimum pressure position 74 (FIG. 7). Although not shown in FIG. 4, such gas flow 80 assumes that propane coupling member 60 is coupled to the threaded portion 61 of the propane tank 16 and with the gas knob 63 of the propane tank 16 turned to an open position, thereby facilitating gas flow 80 from the propane tank 16 (see FIG. 1). The interconnection member 14 defines a gas inlet 82 and a gas outlet 84 adjacent the respective first and second ends 56, 58 of the interconnection member 14, the inlet 82 and the outlet 84 of the interconnection member 14 sized and configured to pass propane gas therethrough. For example, at the first end 56, the gas inlet 82 receives gas from the propane tank 16 (FIG. 1) such that, upon the propane tank being opened, pressurized gas may flow from the propane tank 16 and through the gas inlet 82 such that gas flows through the propane tank coupling member 60 and toward the pressure regulator 10. Further, gas flow may continue from the pressure regulator 10, through the hose 64 and through the gas outlet 84 to flow into components of the cooking station 12 (FIG. 1).

With reference to FIGS. 6A, the pressure regulator 10 extends with a body 86 or frame or shell, the body 86 extending to at least partially define a pressure regulator inlet 88 and a pressure regulator outlet 90. Further, the pressure regulator 10 includes a diaphragm 92, the body 86 and diaphragm 92 extending to at least partially define a compartment 94. As gas flows through the pressure regulator inlet 88, the gas flows into the compartment 94 within the pressure regulator 10 such that pressurized gas flowing through the pressure regulator inlet 88 may provide a gas force 73 pushing upward upon the diaphragm 92. This gas force 73 applied upward to the diaphragm 92 may be equal to the area of the diaphragm times the amount of pressure of the gas. The compartment 94 may move between expanded and contracted positions (see FIG. 7A) via movement of the diaphragm 92, discussed further herein. As the gas flows through the pressure regulator inlet 88, the gas flows adjacent an end portion 96 of a lever arm 98. The end portion 96 of the lever arm 98 may be positioned adjacent to the pressure regulator inlet 88 so as to define a space 100 (see FIG. 6A) therebetween. The space 100 may change between the maximum and minimum pressure positions 72, 74 (FIG. 6) of the pressure regulator 10 as the diaphragm 92 moves from a lowest position and a highest position. As depicted by arrow 80, the gas flows through the compartment 94 and through the pressure regulator outlet 90 so as to then move through various tubular components, such as the hose 64 and through the gas outlet 84 of the interconnection member 12 (see FIGS. 6A and 7A). The gas flowing from the gas outlet 84 of the interconnection member 14 is configured to feed toward and into the gas burners 18 of the cooking station 12 (FIG. 1).

Now with reference to FIGS. 4, 6A and 7A, enlarged cross-sectional views of the pressure regulator are depicted with the knob 70 in the maximum pressure position 72 (see FIG. 6A) and the minimum pressure position 74 (see FIG. 7A). Similar to that previously set forth, description of FIGS. 6A and 7A assume that the propane coupling member 60 is coupled to the threaded portion 61 of the propane tank 16 and with the gas knob 63 of the propane tank 16 turned to the open position, thereby facilitating gas flow 80 from the propane tank 16 (see FIG. 1). The maximum pressure position 72 of the knob 70 preferably is a default position as the maximum pressure position 72 facilitates a pressure that may be typical for conventional pressure regulators. The knob 70 of the pressure regulator 10 may be rotated from the default position or the maximum pressure position 72 to the minimum pressure position, which moves components within the pressure regulator 10 to minimize the gas flow 80 through the pressure regulator and, thus, to the cooking station 12. The pressure regulator 10 may include the knob 70 positioned over the body 86 of the pressure regulator 10, the knob 70 of the pressure regulator 10 rotatable about an axis 102 of the pressure regulator 10 and the axis 102 of the knob 70. As the knob 70 is rotated, various components of the pressure regulator 10 may cooperate together to change or adjust the pressure of the gas being delivered or fed through the pressure regulator 10. With the knob 70 in the maximum pressure position 72, the pressure regulator 10 may feed gas to the cooking station 12 at a pressure of about 11 inches of water column. Such level of pressure is what typical pressure regulators provide, but such pressure regulators at that maximum level of pressure are not adjustable. With the knob 70 in the minimum pressure position 74, the pressure regulator 10 may feed gas to the cooking station 12 at a pressure of about 8.5 inches of water column. As such, the pressure regulator 10 may be sized and configured to adjust the pressure of gas flow toward the cooking station 12 to be anywhere between about 11 inches of water column and about 8.5 inches of water column by adjusting the knob 70 of the pressure regulator 10.

In one embodiment, the pressure regulator 10 may include various internal components that cooperate together with manual movement of the knob 70 about the axis 102 to change or adjust the pressure of the gas being delivered or fed through the pressure regulator 10. For example, in addition to the previously discussed diaphragm 92 and lever arm 98, other internal components of the pressure regulator 10 may include an axil 104, first and second spring caps 106, 108, first and second springs 110, 112, a diaphragm plate 114, and a relief pin 116. The relief pin 116 may be suspended within the diaphragm 92 with the first spring cap 106 and first spring 110, the first spring 110 being biased between the diaphragm plate 114 and the first spring cap 106. The first spring 110 may provide a spring force 71 or main spring force that may be configured to counter against or bias against the gas force 73 being applied against an underside of the diaphragm 92 in compartment 94, previously set forth. Further, the diaphragm plate 114 may exhibit a ridge 118 along one side of the diaphragm plate 114, the ridge 116 sized and configured to maintain one end of the first spring 110 in an upright position. The first spring cap 106 may extend with a flange 120 to also keep the first spring 110 in the upright position. The second spring 112 may be biased and positioned between the second spring cap 108 and the diaphragm plate 114 with the relief pin 116 positioned within the second spring 112 and extending through the diaphragm plate 114.

As the knob 70 is rotated about the axis 102, an inner surface of the knob 70 may cooperate with an outer surface of the axil 104 to move the axil 104 linearly along the axis 102 between a lower position (FIG. 6A) and an upper position (FIG. 7A). With the axil 104 in the lower position, the axil 104 may place compression upon the first spring 110 positioned between the first spring cap 106 and the diaphragm plate 114 and move the diaphragm plate 114 and diaphragm 92 downward to rotate the lever arm 98 about the pin 124 to therefore increase the opening 100 to allow greater flow of gas from the tank 16. In addition, as the diaphragm plate 114 and diaphragm 92 are compressed downward to bias against the gas force 73 placed against the underside of the diaphragm 92, the relief pin 116 also moves downward. Further, as the relief pin 116 moves downward, the lever arm 98 may pivot about a pin axis 122 defined by a pin 124 so that the end portion 96 may tilt upward to enlarge the space 100 defined between the pressure regulator inlet 88 and the end portion 96. In addition to the enlarged space 100, the compartment 94 may become compressed to provide a maximized pressure of gas moving through the pressure regulator 10. Further, this space 100 becomes reduced upon manually rotating the knob 70 to the minimum pressure position 74 such that the axil 104 moves to the upper position so that the axil 104 moves into a hollow space 126 defined in the knob 70. For example, movement of the knob 70 to the minimum pressure position 74 reduces the amount of compression on the first spring 110 or main spring which decreases the downward spring force 71 of the first spring 110. The gas force 73 being, for the moment, greater than the downward spring force 71, pushes the diaphragm 92 upward causing the lever arm 98 to rotate about pin 124 thereby decreasing the space 100. The decreased space 100 restricts momentarily the gas flow 80 into the area below the diaphragm 92. The gas flow 80 out of the regulator 10 being less than the gas flow into the regulator 10 causes the gas force 73 to decrease until it matches the downward spring force 71. The gas force 73 with the knob 70 rotated to the minimum pressure position 74 is now less than the gas force 73 was with the knob 70 rotated to the maximum pressure position 72. As such, as the knob 70 is manually rotated to move the axil 104 to the upper position, each of the diaphragm 92, diaphragm plate 114 and relief pin 116 move upward to expand the compartment 94. Further, the upward movement of the relief pin 116 pivots the lever arm 98 about the pin axis 122 so that the end portion 96 of the lever arm 98 moves closer to the pressure regulator inlet 88 to, thereby, reduce the space 100 defined between the end portion 96 the pressure regulator inlet 88. With this reduced space 100 adjacent the pressure regulator inlet 88 and the compartment 94 being expanded (via movement of the diaphragm 92), the pressure of the propane gas flowing through the pressure regulator can be minimized to about 8.5 inches of water column. Further, the lever arm 98 may extend at an angle (such as different angles) relative to the longitudinal axis 59 upon the knob 70 being moved to the maximum pressure position 72 or to the minimum pressure position 74. In this manner, the pressure regulator 10 may be sized and configured to adjust the pressure of the propane gas flowing through the pressure regulator 10.

Furthermore, upon the gas knob 63 of the propane tank 16 being in the open position so that gas may flow through the pressure regulator 10, manually moving the burner valve knobs 40 to a desired level may also adjust the components of the pressure regulator until the internal components reach equilibrium. For example, when gas begins flowing from the pressure regulator 10, the pressure under the diaphragm 92 decreases, making the forces on the diaphragm 92 unbalanced. The downward spring force 71 of the first spring 110 may become greater than the upward gas force 73 under the diaphragm 92 such that the diaphragm 92 may move downward. When the diaphragm 92 moves downward, the lever arm 98 rotates about pin 124. This rotation lifts the end portion 96 (pad) off the pressure regulator inlet 88 allowing higher pressure gas within the compartment 94 below the diaphragm 92. The internal components of the pressure regulator 10 will reach equilibrium at the flow rate of the gas determined by the position of the burner valve knobs valves 40. When the burner valve knobs 40 are opened further to allow more gas to the gas flame burners 18, the internal components of the pressure regulator 10 will adjust to open the inlet orifice 88 more to allow more propane to flow through the regulator and through the valves of the burner valve knobs 40 and to the gas flame burners 18.

Also, when the burner valve knobs 40 are turned to the off or closed position, the high pressure from the propane tank 16 will continue to flow for a very short amount of time. This flow of high pressure propane under the diaphragm 92 pushes the diaphragm assembly upward and causes the lever arm 98 to rotate about pin 124. The end portion 96 on the lever arm 98 closes off the pressure regulator inlet 88, which causes the flow of gas to stop.

Further, as previously set forth, rotating the knob 70 of the pressure regulator 10 may adjust the internal components of the pressure regulator 10. For example, rotating the knob 70 of the pressure regulator 10 changes the amount of compression of the first spring 110. By turning the knob 70 and increasing the amount of force from the first spring 110, the diaphragm 92 moves downward, which will increase the opening of the pressure regulator inlet 88 to allow more high pressure gas to flow into the pressure regulator below the diaphragm 92. This flow of gas pushes the diaphragm 92 upward to then decrease the opening of the pressure regulator inlet 88, until the internal components reach equilibrium and stabilize. The rotation of the knob 70 of the pressure regulator 10 changes the compression of the first spring 110, which changes the amount of pressure needed to reach equilibrium and/or stop or minimize the flow of gas through the pressure regulator inlet 88.

As previously set forth, the pressure regulator 10 may preferably be sized and configured to be adjustable so that gas flow includes a pressure moving to the cooking station 12 to be anywhere between about 11 inches of water column and about 8.5 inches of water column, the adjustability being facilitated with manual movement of the knob 70 of the pressure regulator 10. In another embodiment, the pressure regulator 10 may be sized and configured to exhibit maximum pressure levels of anywhere between about 11 inches water column to about 13.5 inches water column or even higher of about 15 inches water column. As such, in some embodiments, the pressure regulator 10 may be sized and configured to adjust the pressure of gas flow toward the cooking station 12 to be anywhere between about 13.5 inches of water column and about 8.5 inches of water column by adjusting the knob 70 of the pressure regulator 10. In another embodiment, the pressure regulator 10 may be sized and configured to adjust the pressure of gas flow toward the cooking station 12 to be anywhere between about 15 inches of water column and about 8.5 inches of water column by adjusting the knob 70 of the pressure regulator 10. In still another embodiment, the pressure regulator 10 may be sized and configured to exhibit minimum pressure levels of about 8 inches of water column or even about 7.5 inches of water column. As such, in some embodiments, the pressure regulator 10 may be sized and configured to adjust the pressure of gas flow toward the cooking station 12 to be anywhere between about 11 inches of water column and about 8 inches of water column. In still another embodiment, the pressure regulator 10 may be sized and configured to adjust the pressure of gas flow toward the cooking station 12 to be anywhere between about 11 inches of water column and about 7.5 inches of water column by adjusting the knob 70 of the pressure regulator 10. In still another embodiment, the pressure regulator 10 may be sized and configured to adjust the pressure of gas flow toward the cooking station 12 to be anywhere between about 15 inches of water column and about 7.5 inches of water column by adjusting the knob 70 of the pressure regulator 10. In this manner, the pressure regulator 10 may be adjusted to various levels of pressure above and below that which is found in typical fixed pressure regulators.

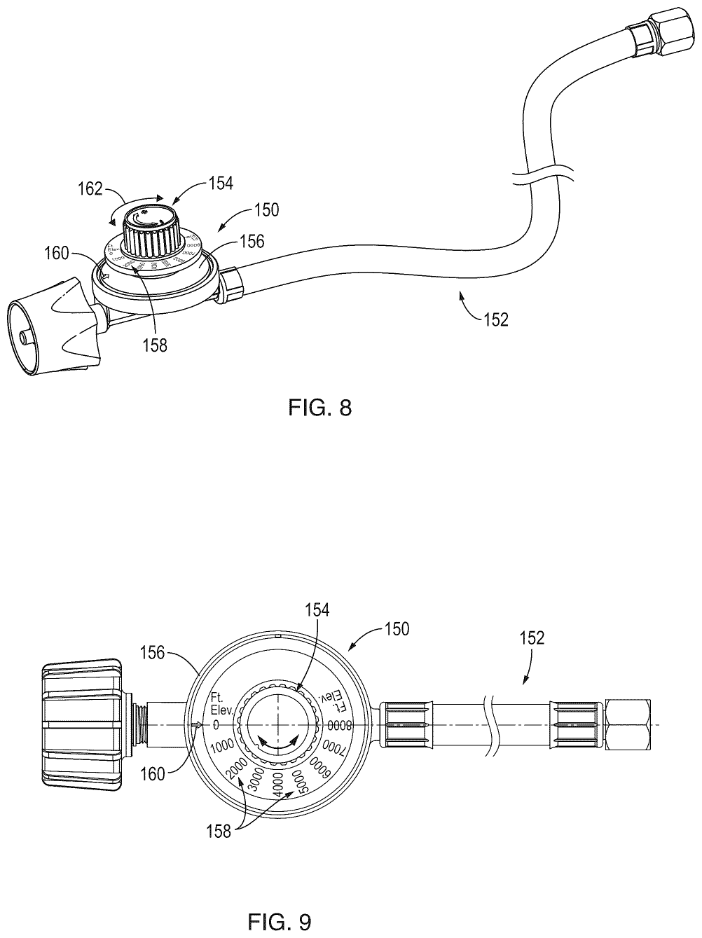

Now with reference to FIGS. 1 and 8-9, another embodiment of an adjustable pressure regulator 150 of an interconnection member 152 sized and configured to be implemented with an outdoor cooking station, such as the outdoor cooking station 12 of FIG. 1, is provided. The adjustable pressure regulator 150 of this embodiment may be an altitude compensating pressure regulator such that the adjustable pressure regulator 150 may be sized and configured for a user to adjust the adjustable pressure regulator 150 to correspond with an altitude at the geographical location where the user may be cooking food. The adjustable pressure regulator 150 of this embodiment may be substantially similar in functionality and structure as that set forth in the pressure regulator 10 (FIG. 6A) of the previous embodiment. As such, similar structure of the previous embodiment may be applicable as description of structure and functions of this embodiment. Further, in this embodiment, the adjustable pressure regulator 150 may be sized and configured to adjust the pressure of gas flow toward the cooking station 12 to be anywhere between the range of about 11 inches of water column and about 15 inches of water column by adjusting a knob 154 relative to a body 156 of the pressure regulator 150, similar to the previous embodiment.

In this embodiment, the knob 154 and the body 156 of the pressure regulator 150 may be associated with altitude indicia 158. In a further embodiment, the altitude indicia 158 may be associated directly with the knob 154 of the pressure regulator 150. With such embodiments, a user may rotate the knob 154 relative to the body 156 of the pressure regulator 150 so that the altitude indicia 158 may correspond with a marking or marking indicia 160 associated with the knob 154 or body 156 of the pressure regulator 150. In another embodiment, the altitude indicia 158 may be located directly on the body 156 or another portion of the pressure regulator 150 adjacent the knob 154. The marking indicia 160 of the pressure regulator 150 may be an arrow type marking or a dash type marking. In this embodiment, the marking indicia 160 may be located on the body 156 of the pressure regulator 150 or, in another embodiment, located on another portion of the pressure regulator 150 adjacent to the knob 154. As in previous embodiments, the knob 154 may be rotatable, as shown by arrow 162, for adjusting a pressure that may be funneled or advanced through the pressure regulator 150 and to the burners of the cooking station 12.

The altitude indicia 158 may include numerals formed in or on the knob 154 so that the numerals are fixed to the knob 154. The altitude indicia 158 may include numerals representing feet above sea level, such as 0, 1000, 2000, 3000, 4000, 5000, 6000, 7000 and 8000. As such, the numeral “0” may represent zero feet above sea level (or just sea level) and the numeral “1000” may represent one thousand feet above sea level, and so on, such that the numeral “8000” may represent eight thousand feet above sea level. The numbers representing the altitude indicia 158 may continue higher than “8000” feet above sea level, such as “8500” or “9000” feet elevation above sea level. As such, the adjustable pressure regulator 150 may be employed by a user by adjusting the knob 154 by rotating the knob 154 to a position relative to the altitude that the person may be geographically located at while using the pressure regulator 150 associated with a cooking station 12. In another embodiment, the altitude indicia 158 may be other numbers or symbols that may be intended to represent the altitude a person is using the adjustable pressure regulator 150 above sea level, such as 0, 1 k, 2 k, 3 k, 4 k, 5 k, 6 k, 7 k, and 8 k, where 0 may represent sea level, “1 k” may represent one thousand feet elevation above sea level, “2 k” may represent two thousand feet elevation above sea level, and so on, such that “8 k” may represent eight thousand feet above sea level. In another embodiment, instead of the altitude indicia 158 being 0, 1 k, 2 k, 3 k, 4 k, 5 k, 6 k, 7 k, and 8 k, the altitude indicia 158 may be 0, 1, 2, 3, 4, 5, 6, 7 and 8, which would correspond to multiples of 1,000, as set forth above.

The pressure output of the pressure regulator 150 may operate under a gauge pressure principle. The gauge pressure may change or vary depending on the atmosphere or the geographical elevation or height of the pressure regulator 150 above sea level. With an increase in altitude there is a decrease in air pressure. This decrease in air pressure may cause the pressure regulator 150 to deliver propane at a lower density, resulting in fewer BTUs (“British Thermal Units”) being delivered to the burners of the cooking station 12. The adjustable pressure regulator 150, set forth herein, may compensate for the loss of BTUs upon one employing the adjustable pressure regulator 150 upon being located at an increase in geographical altitude. As such, the altitude indicia 158 positioned on the knob 154 may be positioned on the knob 154 so that a user may adjust or rotate the knob 154, and thereby adjust the pressure output, to correspond with the altitude or elevation above sea level that the user may be geographically located and cooking with the cooking station 12. In this manner, the flow of propane and the heat generated at the burners 18 of the cooking station 12 may be delivered and provided at substantially the same amount of propane or BTUs that would be delivered at sea level.

For example, the normal or typical pressure passing through a non-adjustable pressure regulator to an outdoor gas cooking appliance may be about 11 inches water column at sea level. When the regulator is taken to a higher altitude the force of the atmosphere on the diaphragm is decreased (see, e.g., diaphragm 92 of FIG. 6A). As such, upon the burners being turned off, the internal valve closes at a lower propane pressure. The pressure of the propane is still at 11 inch water column, however, that 11 inch water column is with respect to the atmospheric pressure. A lower atmospheric pressure means a lower propane pressure, which results in fewer BTU's going to the burners.

With reference to FIGS. 1, 6A, 7A, 8 and 9, to compensate for the lower BTUs, the adjustable regulator 150 set forth herein may be employed. The adjustable regulator 150 may increase the force of the first spring 110 on the diaphragm 92 to offset the decrease in force from the lower atmospheric pressure at a higher altitude than sea level. As such, at for example 8000 feet elevation above sea level, the output pressure of the adjustable pressure regulator 150 may be increased from 11 inch water column to about 14.7 inch water column (or about 15 inch water column) to get the same amount of BTUs going to the burners 18 of the cooking station 12 that would occur at sea level with an output pressure of 11 inch water column.

Further, by way of example, if one was to drive up into the mountains to a location say 2,000 feet or 4,000 feet elevation above sea level with the cooking station 12, the knob 154 of the adjustable pressure regulator 150 may be adjusted to the 2,000 or 4,000 mark, respectively, of the altitude indicia 158 relative to the marking indicia 160 to maintain the level of BTUs that would occur at sea level with a pressure of 11 inches water column. As such, by adjusting the knob 154 to the 2,000 or 4,000 mark of the atmosphere indicia 158, the pressure output may be adjusted to 12.0 or 13.0 inches water column, respectively, to compensate for the difference in altitude to maintain the same level of BTUs that occur at sea level. Similarly, if one was at a higher elevation, such as 6,000 feet or 8,000 feet elevation above sea level, one may adjust the knob 154 of the pressure regulator 150 to correspond with the 6,000 feet or 8,000 feet elevation mark of the altitude indicia 158 in order to compensate and obtain the level of BTUs that would occur at sea level with a pressure of 11 inches water column. Such adjustment of the knob 154 of the adjustable pressure regulator 150 to the 6,000 or 8,000 mark of the altitude indicia 158, may increase the pressure of gas output to about 13.8 or 14.7 inches water column of pressure, respectively, in order to obtain a similar amount of BTUs that would occur at sea level with a pressure of 11 inches water column. In this manner, the pressure regulator 150 may compensate and provide consistency in the amount of BTUs heating a cooking surface 20 of the cooking station 12, regardless of the cooking station 12 being close to sea level or at a location at a higher geographical elevation.

In one embodiment, the adjustable pressure regulator 150 may be sized and configured to adjust the pressure of gas flow toward the cooking station 12 to be anywhere between the range of about 11 inches of water column and about 15 inches of water column by adjusting the knob 154 relative to the body 156 of the pressure regulator 150. In another embodiment, the adjustable pressure regulator 150 may be sized and configured to adjust the pressure of gas flow toward the cooking station 12 to be anywhere between the range of about 11 inches of water column and about 14.7 inches of water column by adjusting the knob 154 relative to the body 156 of the pressure regulator 150. As previously set forth, such pressure range may correspond with altitudes between about sea level and about 8000 feet elevation above sea level, as shown with the altitude indicia 158 associated with the knob 154, so that by turning the knob 154 relative to the body 156, one may adjust the pressure output of the pressure regulator 150 to appropriately correspond with the persons current geographical location and the altitude thereof. In this manner, the pressure regulator 150 may compensate and provide consistency in the amount of BTUs heating a cooking surface 20 of the cooking station 12, regardless of the person cooking close to sea level or at a location at a higher geographical elevation.

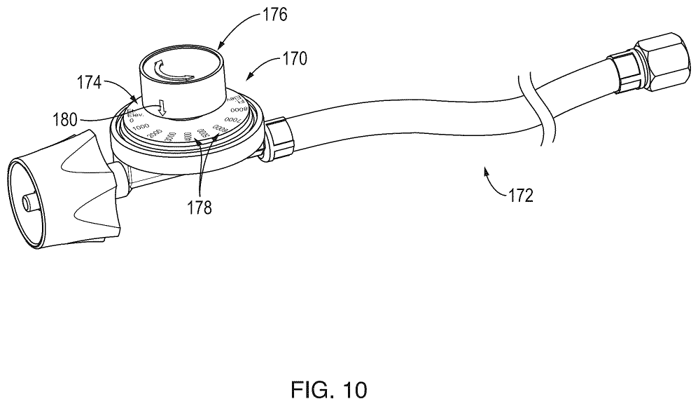

Now with reference to FIG. 10, another embodiment of an adjustable pressure regulator 170 of an interconnection member 172 is provided. In this embodiment, the adjustable pressure regulator 170 may include a body 174 and a knob 176 rotatably positioned adjacently above the body 174 such that the knob 176 may be adjusted with rotation, as in previous embodiments. Further, the adjustable pressure regulator 170 may include altitude indicia 178 and a marking indicia 180 associated with the pressure regulator 170. In this embodiment, the altitude indicia 178 may be positioned on the body 174 of the pressure regulator 170 and the marking indicia 180, such as an arrow or a dash type marking, may be positioned on the knob 176. The pressure regulator 170 of this embodiment includes features and structure that may be substantially similar or the same to that which is described in the previous embodiments and, therefore, the previous description of the previous embodiments set forth herein is applicable to this embodiment.

The various structural components of the embodiments of the interconnection member 14, 152, 172, set forth herein, as well as the structural components of the cooking station 12 may be formed of various metallic materials, such as steel, stainless steel, copper, brass, aluminum or any other suitable material with high temperature ratings, such as various suitable polymeric materials. Further, the various structural components of the outdoor cooking station 12 and interconnection member 14, 152, 172 may be formed from known structural components, such as sheet metal at various gauges/thicknesses or other known metallic structures, such as tubing or the like, and may be formed and manufactured through various known processes and techniques known in the art, such as casting, welding, rolling, bending, pressing, fastening, etc., as known by one of ordinary skill in the art.

While the invention may be susceptible to various modifications and alternative forms, specific embodiments have been shown by way of example in the drawings and have been described in detail herein. Further, the structural features of any one embodiment disclosed herein may be combined or replaced by any one of the structural features of another embodiment set forth herein. However, it should be understood that the invention is not intended to be limited to the particular forms disclosed. Rather, the invention includes all modifications, equivalents, and alternatives falling within the spirit and scope of the invention as defined by the following appended claims.

1. A pressure regulator for delivering gas to a cooking station, the cooking station being couplable to gas fuel controllable with a gas knob, the pressure regulator comprising:
a body with a knob rotatably coupled to the body, the knob is manually rotatable about an axis defined by the knob, the body defining a gas inlet and a gas outlet; and
a lever arm positioned within the body, the lever arm having an end portion positioned adjacent the gas inlet such that, upon the gas knob being in an open position, the lever arm is pivotable via rotation of the knob such that rotation of the knob adjusts gas flow pressure through the body between about 11 inches of water column and about 15 inches of water column;
wherein a surface of the body and knob are associated with altitude indicia so that the knob is turnable to a position to adjust gas flow pressure through the body that corresponds with and compensates for a geographical altitude.

2. The pressure regulator of claim 1, wherein the altitude indicia comprises marking indicia, the marking indicia being positioned on at least one of the knob and the body.

3. The pressure regulator of claim 1, wherein the knob is turnable relative to the body to adjust the gas flow pressure through the body.

4. The pressure regulator of claim 1, wherein the altitude indicia comprises numerals associated with elevation above sea level.

5. The pressure regulator of claim 1, wherein the knob is rotatable to linearly move an axil, the axil operatively coupled to at least one spring, the at least one spring operatively coupled to the lever arm.

6. The pressure regulator of claim 1, further comprising a compartment, the compartment defined at least partially by the body and a diaphragm, the diaphragm moveable between an expanded position and a compressed position.

7. The pressure regulator of claim 6, wherein, upon the diaphragm being in the compressed position, the lever arm is in a first pivoted position and, upon the diaphragm being in the expanded position, the lever arm is in a second pivoted position.

8. The pressure regulator of claim 6, wherein the diaphragm extends alongside a diaphragm plate.

9. The pressure regulator of claim 1, wherein the knob is rotatable to linearly move a relief pin, the relief pin operatively coupled to at least one spring and the lever arm.

10. The pressure regulator of claim 9, wherein the relief pin is linearly movable along the axis defined by the knob and relative to the body.

11. An outdoor cooking station configured to be gas heated with a propane tank, the outdoor cooking station comprising:
a main body with gas burners, the gas burners configured to receive pressurized gas therethrough;
an elongated interconnection member extending between a first end portion and a second end portion, the first end portion sized and configured to be coupled to the propane tank and the second end portion sized and configured to be operatively coupled to the gas burners so that gas can move from the propane tank to the gas burners of the main body; and
a pressure regulator positioned between the first end portion and the second end portion of the interconnection member, the pressure regulator including a body and a lever arm positioned within the body, the body having a knob rotatably coupled to the body, the knob manually rotatable about an axis defined by the knob, the body defining a gas inlet and a gas outlet, the lever arm extends with an end portion positioned adjacent the gas inlet, the lever arm pivotable via rotation of the knob such that rotation of the knob is configured to adjust gas flow pressure through the body between about 11 inches of water column and about 15 inches of water column;
wherein a surface of the body and knob are associated with altitude indicia so that the knob is turnable to a position to adjust gas flow pressure through the body that corresponds with and compensates for a geographical altitude.

12. The outdoor cooking station of claim 11, wherein the altitude indicia comprises marking indicia, the marking indicia being positioned on at least one of the knob and the body.

13. The outdoor cooking station of claim 11, wherein the knob is turnable relative to the body to adjust the gas flow pressure through the body.

14. The outdoor cooking station of claim 11, wherein the altitude indicia comprises numerals associated with elevation above sea level.

15. The outdoor cooking station of claim 11, wherein the interconnection member comprises a flexible gas hose extending from the pressure regulator to the second end portion of the interconnection member.

16. The outdoor cooking station of claim 11, wherein the knob is rotatable to linearly move an axil, the axil operatively coupled to at least one spring, the at least one spring operatively coupled to the lever arm.

17. The outdoor cooking station of claim 11, further comprising a compartment, the compartment defined at least partially by the body and a diaphragm, the diaphragm moveable between an expanded position and a compressed position.

18. The outdoor cooking station of claim 17, wherein, upon the diaphragm being in the compressed position, the lever arm is in a first pivoted position and, upon the diaphragm being in the expanded position, the lever arm is in a second pivoted position.

19. The outdoor cooking station of claim 17, wherein the diaphragm extends alongside a diaphragm plate.

20. The outdoor cooking station of claim 11, wherein the knob is rotatable to linearly move a relief pin, the relief pin operatively coupled to at least one spring and the lever arm.

21-39. (canceled)
